(19) United States
(12) Patent Application Publication
(10) Pub. No.: US 2014/0019837 A1
(43) Pub. Date: Jan. 16, 2014

(54) ONLINE DOCUMENT DISTRIBUTION METHOD AND SYSTEM FOR MOBLE DEVICE

(71) Applicant: EPVOL CO., LTD., Gwangjin-gu (KR)

(72) Inventors: Dong Yoon SHIN, Seoul (KR); Jin Young KWAK, Seoul (KR)

(73) Assignee: EPVOL CO., LTD., Gwangjin-gu (KR)

(21) Appl. No.: 13/630,418

(22) Filed: Sep. 28, 2012

(30) Foreign Application Priority Data
Jul. 13, 2012 (KR) 10-2012-0076726

(51) Int. Cl. G06F 17/00

(52) U.S. Cl. 715/205

(57) ABSTRACT

An online document distribution method for a mobile device may include receiving a selection of one online document among a plurality of online documents from a first user, generating a link address of the selected online document using unique information of the first user through an application installed in a mobile device of the first user, transmitting the generated link address to at least one second user device selected by the first user, detecting an access to the selected online document through the generated link address, and updating a score of the first user in response to the detected access to the selected online document.

### CROSS-REFERENCE TO RELATED APPLICATION

This application claims the priority benefit of Korean Patent Application No. 10-2012-0076726, filed on Jul. 13, 2012, in the Korean Intellectual Property Office, the disclosure of which is incorporated herein by reference.

### BACKGROUND

1. Field of the Invention

The present invention relates to an online document distribution method and system, and more particularly, to a technique for distributing an online document through an application installed in a mobile device.

2. Description of the Related Art

An online document distribution technology may transmit and distribute an online document through a smart device. The smart device may include a personal computer (PC), a tablet PC, a personal digital assistant (PDA) terminal, a mobile device, and the like.

### SUMMARY

An aspect of the present invention provides a method, apparatus, and system for appropriately evaluating a first user distributing an online document.

Another aspect of the present invention also provides a method, apparatus, and system for determining a number of effective user accesses to the online document distributed by the first user through a link address of the online document.

Still another aspect of the present invention also provides a method, apparatus, and system for objectively evaluating the first user contribution to distribute the online document, based on unique information of the first user used in generating the link address of the online document.

Yet another aspect of the present invention also provides a method, apparatus, and system for preventing an invalid access by using a unique number or an access history for each user equipment having received the link address of the online document to evaluate the first user contribution.

According to an aspect of the present invention, there is provided an online document distribution method for a mobile device, including receiving a selection of one online document among a plurality of online documents from a first user, generating a link address of the selected online document using unique information of the first user through an application installed in a mobile device of the first user, transmitting the generated link address to at least one second user device selected by the first user, detecting an access to the selected online document through the generated link address, and updating a score of the first user in response to the detected access to the selected online document.

The method may further include providing a list of the plurality of online documents.

The generating of the link address of the selected online document may include encrypting at least one of unique information of the first user, a number of the online document, and a language identifier using a predetermined encryption scheme, and combining the encryption result with a base uniform resource locator (URL) of the online document.

The transmitting of the generated link address may include selecting a transmission medium.

The selecting of the transmission medium may include selecting one server among a plurality of servers, and transmitting the generated link address through the selected server.

The detecting of the access to the selected online document may include detecting the access to the selected online document by the second user device through the generated link address, and determining whether a number of accesses by the second user device is greater than a predetermined value.

The determining whether the number of accesses by the second user device is greater than the predetermined value may include determining whether the number of accesses by the second user device is greater than the predetermined value, based on a unique number assigned to the second user device or an access history of online documents accessed by the second user device.

The updating of the score of the first user may further include providing the first user with a reward in a form of a coupon, points, and cash, based on the score of the first user.

According to another aspect of the present invention, there is provided a method of distributing a document of a business subscriber online, the method including providing a document registered and distributed by a business subscriber through an application installed in a mobile device of a first user, identifying unique information of the first user, generating a link address of the document using the unique information of the first user, transmitting the generated link address to at least one second user device selected by the first user, detecting an access to the document through the generated link address, and updating a score of the first user in response to the detected access to the document.

The identifying of the unique information of the first user may include identifying the unique information of the first user to select a predetermined document from a list of documents registered and distributed by the business subscriber.

The updating of the score of the first user may further include transmitting the updated score to the business subscriber corresponding to the first user.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an online document distribution system according to an embodiment of the present invention;

FIG. 2 is a diagram illustrating an example of an online document;

FIG. 3 is a diagram illustrating an example of a display for selecting a transmission medium;

FIG. 4 is a diagram illustrating an operation of transmitting a link address of an online document according to an embodiment of the present invention; and

FIG. 5 is a flowchart illustrating an online document distribution method for a mobile device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

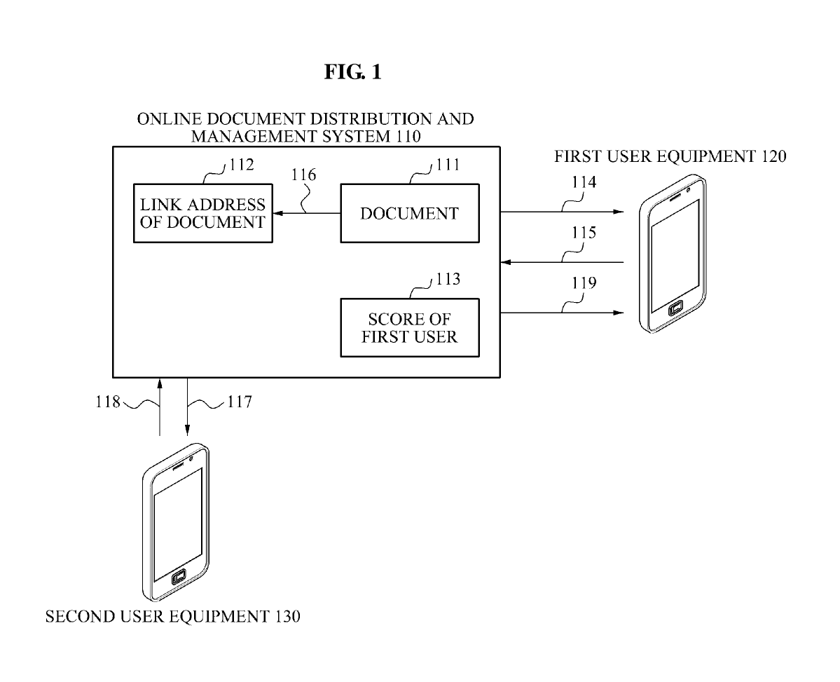

FIG. 1 is a diagram illustrating an online document distribution system according to an embodiment of the present invention.

Referring to FIG. 1, an online document distribution and management system 110, a first user equipment 120, and a second user equipment 130 may be provided. Here, the first user equipment 120 may include a device of a business subscriber.

The online document distribution and management system 110 may include a list of a plurality of online documents 111, and the plurality of online documents 111 may be registered and distributed by the business subscriber. Here, the plurality of online documents 111 may correspond to documents accessible via a network, for example, a web page. The plurality of online documents 111 may include a predetermined event, an advertising document, a marketing document, a notification document, and the like.

The business subscriber or a plurality of users may access the online document distribution and management system 110 to register an advertising document, a marketing document, a notification document, and the like. The registered online documents may be provided to the first user equipment 120 in a form of a list. The first user equipment 120 may search for a desired online document among online documents included in the list, and may distribute a link address of the found online document to other users.

The business subscriber may register an advertising document in the online document distribution and management system 110 to advertise a new product or service. In this instance, employees of a corresponding company may search for the advertising document for the new product or service in the online document distribution and management system 110, and may distribute a link address of the found advertising document to friends or relatives. Some of the friends or relatives may or may not open the advertising document. The present invention may monitor a number of accesses to the corresponding advertising document for each employee distributing the link address, and may determine a score for each employee based on the monitoring result. The score may be used as a material for employee performance appraisal.

The online document distribution and management system 110 may generate a link address 112 of the online document 111 using unique information of the first user to allow users to link to the online document 111 through the link address 112, and may manage a score 113 of the first user based on a number of user accesses to the online document 111 through the generated link address 112. In this instance, a number of accesses by the corresponding device may be set less than or equal to a predetermined value when a device accesses the online document 111 through the link address 112 of the online document 111 multiple times. For example, when a device accesses the online document 111 through the link address 112 of the online document 111 multiple times, a number of accesses by the corresponding device may be set to be ‘1’. A further detailed description is provided below. According to a method of the present invention, in operation 114, a list of a plurality of online documents 111 may be provided to the first user equipment 120. The plurality of online documents 111 may be provided to the first user equipment 120 in which an application is installed to execute the method of the present invention, and a display order of the plurality of online documents 111 may be different depending on preferences of the first user. For example, the first user may set to display the plurality of online documents 111 in an order of popularity or by date created. Also, a display location of each of the plurality of online documents 111 may be set based on costs involved in registering the plurality of online documents 111.

In operation 115, the first user may select one online document among the plurality of online documents 111, and the online document distribution and management system 110 may receive the selection.

To improve convenience of the first user searching for a desired online document, the application for executing the method of the present invention may provide a search tool.

In operation 116, the online document distribution and management system 110 may generate the link address 112 of the selected online document using unique information of the first user through the application installed in the first user equipment 120. The unique information of the first user may correspond to predetermined information being generated by the first user executing, for example, logging in the application installed in the first user equipment 120.

The link address 112 of the online document may be generated by encrypting at least one of the unique information of the first user, a number of the online document, and a language identifier using a predetermined encryption scheme, and by combining the encryption result with a base uniform resource locator (URL) of the online document.

For example, assume that the base URL of the online document is ‘http://ps.snsquare.com’ the unique information of the first user is ‘124’, the number of the online document is ‘100’, and the language identifier is ‘ko’. For encryption, the present invention may convert a decimal number into a hexadecimal number.

In this case, the link address 112 of the online document may be generated as follows:

http://ps.snsquare.com+/ko/+7B+7C=http://ps.snsquare.com/ko/7B7C

Here, ‘ko’ denotes the language identifier, ‘7B’ denotes an encryption result obtained by converting the unique information ‘124’ of the first user into a hexadecimal number, and ‘7C’ denotes an encryption result obtained by converting the number ‘100’ of the online document into a hexadecimal number.

In operation 117, the online document distribution and management system 110 may transmit the generated link address 112 to at least one second user equipment 130 selected by the first user. In this instance, the first user may correspond to an employee of the business subscriber, and the second user may correspond to a friend or relative of the first user.

The application installed in the first user equipment 120 may provide a phonebook or phone number directory to help the first user to select the second user. The application installed in the first user equipment 120 may access a list of phone numbers provided basically to the first user equipment 120 and a list of friends on various social networking services (SNSs), and through this access, may provide a phonebook or an embedded phone number directory.

In this instance, the first user may generate a receiver list using the first user equipment 120 in which the application is installed, and may select the second user to receive the link address 112 from the receiver list.

Also, the first user may select a transmission medium to be used to transmit the link address 112.

In operation 118, the online document distribution and management system 110 may detect an access to the selected online document through the link address 112.

The online document distribution and management system 110 may detect an access to the selected online document 111 by the second user equipment 130 through the generated link address 112, and may determine whether a number of accesses by the second user equipment 130 is greater than a predetermined value. The online document distribution and management system 110 may obtain a number of accesses by the second user equipment 130 using a unique number assigned to the second user equipment 130 or an access history of online documents accessed by the second user equipment 130, for example, a cookie and the like, and may compare the obtained number of accesses to a predetermined value. Accordingly, an invalid access may be prevented. For example, when the predetermined value is ‘1’, although a number of accesses to the online document by the same device exceeds ‘1’, the corresponding number of accesses may be determined to be ‘1’. This may be applied, except when the same user accesses the online document 111 using different devices through the link address 112.

In response to the detected access to the online document by the second user equipment 130, the online document distribution and management system 110 may update the score 113 of the first user. As the number of accesses increases, the score 113 of the first user may be increased.

In operation 119, the online document distribution and management system 110 may provide the first user with a reward in a form of, for example, a coupon, a point, and cash, based on the score 113 of the first user.

As described in the foregoing, the first user may include a business subscriber. In such a case, the reward for the first user may be used to evaluate the performance of the first user.

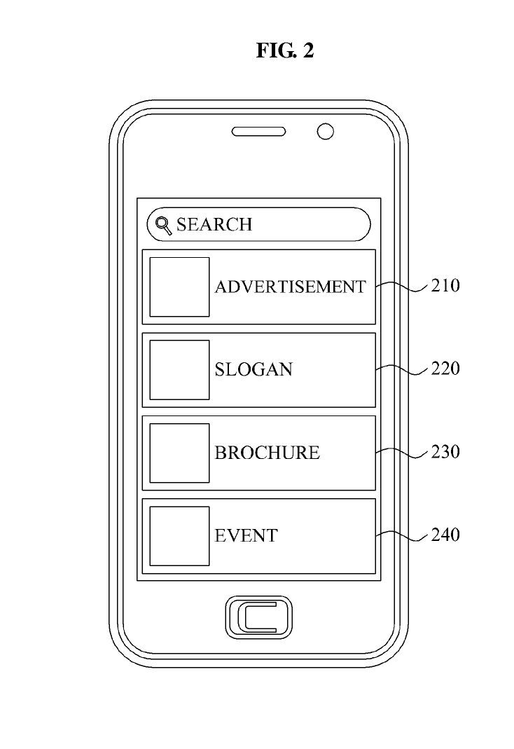

FIG. 2 is a diagram illustrating an example of an online document.

Referring to FIG. 2, a plurality of online documents 210, 220, 230, and 240 may be provided to the first user equipment by the online document distribution and management system 110 of FIG. 1.

The plurality of online documents may include a document registered by a business subscriber as well as an advertising document and a marketing document. For example, the plurality of online documents may include an advertisement 210, a slogan 220, a brochure 230, and an event 240. The first user may select at least one of the plurality of online to documents 210, 220, 230, and 240 through the first user equipment.

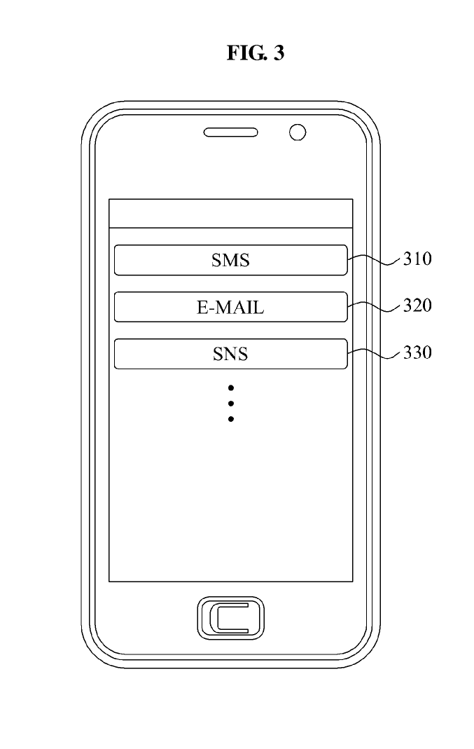

FIG. 3 is a diagram illustrating an example of a display for selecting a transmission medium.

Referring to FIG. 3, a transmission medium may be selected to transmit the link address of FIG. 1 to at least one second user equipment selected by the first user.

The first user may select one transmission medium among a plurality of transmission media, for example, a short messaging service (SMS) 310, an e-mail 320, an SNS 330, and the like. Here, the SNS-based transmission medium 330 may provide an instant messaging service and an SNS service, and may include, for example, Kakao Talk, MyPeople, Facebook, Twitter, and the like.

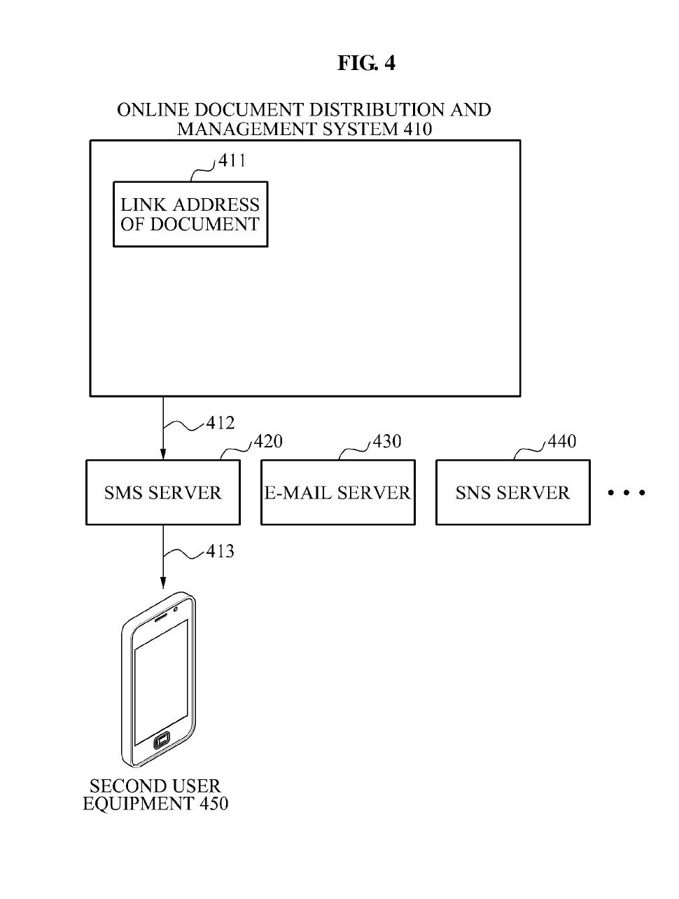

In the selecting of the transmission medium, selecting of one server among a plurality of servers and transmitting of the generated link address through the selected server is described in detail with reference to FIG. 4 below.

FIG. 4 is a diagram illustrating an operation of transmitting a link address of an online document according to an embodiment of the present invention.

Referring to FIG. 4, an online document distribution and management system 410, a plurality of servers 420, 430, and 440, and a second user equipment 450 may be provided.

The first user may generate a receiver list using the first user equipment in which the application is installed, and may select a second user to receive a link address 411 of an online document from the receiver list.

The link address 411 may be transmitted to at least one second user equipment 450 selected by the first user. In this instance, the first user may select a transmission medium to be used to transmit the link address 411.

According to the method of the present invention, in operation 412, the first user may select one server among an SMS server 420, an e-mail server 430, an SNS server 440, and the like, as the transmission medium. Here, the SNS server 440 may include, for example, a to Kakao Talk server, a MyPeople server, a Facebook server, a Twitter server, and the like.

In operation 413, the link address 411 may be transmitted to the second user equipment 450 through the selected server.

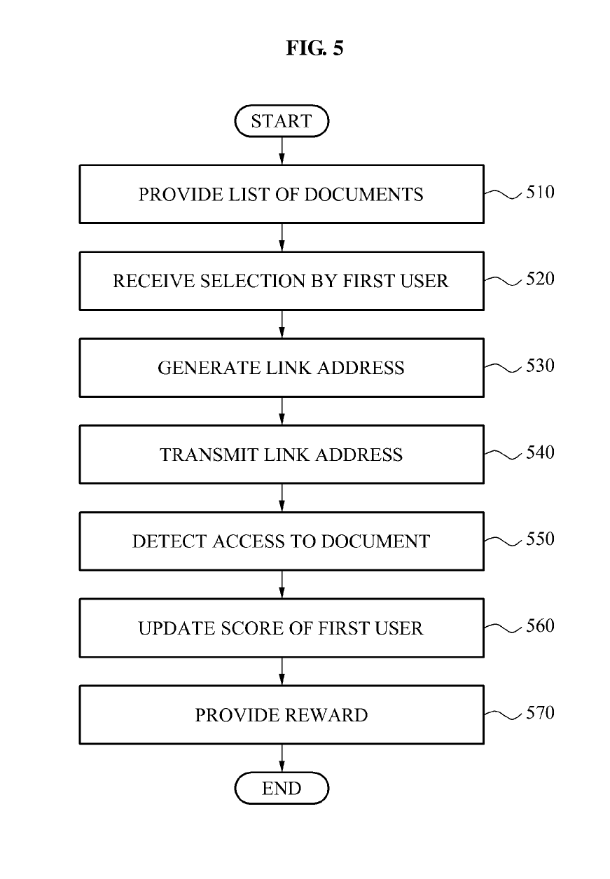

FIG. 5 is a flowchart illustrating an online document distribution method for a mobile device according to an embodiment of the present invention.

Referring to FIG. 5, in operation 510, a list of a plurality of online documents may be provided to a first user.

In operation 520, a selection for one online document among the plurality of online documents may be received from the first user.

In operation 530, a link address of the selected online document may be generated using unique information of the first user through an application installed in first user equipment. Here, the unique information of the first user may correspond to predetermined information being generated by executing, for example, a log-in to the application installed in the first user equipment.

The link address of the online document may be generated by encrypting at least one of the unique information of the first user, a number of the online document, and a language identifier using a predetermined encryption scheme, and by combining the encryption result with a base URL of the online document.

In operation 540, the generated link address may be transmitted to at least one second user equipment selected by the first user. The first user may generate a receiver list using the first user equipment in which the application is installed, and may select a second user to receive the link address among the receiver list. In this instance, the first user may select a transmission medium to be used to transmit the link address. The selecting of the transmission medium may include selecting one server among a plurality of servers and transmitting the link address through the selected server. Here, when the first user is a business subscriber, the online document may correspond to a document distributed by the to business subscriber.

In operation 550, an access to the selected online document through the transmitted link address may be detected. When an access to the selected online document by the second user equipment through the link address is detected, a determination may be made on whether a number of accesses by the second user equipment is greater than a predetermined value. The number of accesses by the second user equipment may be determined based on a unique number assigned to the second user equipment or an access history of online documents accessed by the second user equipment.

In operation 560, a score of the first user may be updated in response to the detected access to the online document by the second user equipment.

In operation 570, the first user may be provided with a reward in a form of, for example, a coupon, a point, and cash, based on the score of the first user.

The units described herein may be implemented using hardware components, software components, and combinations thereof. For example, the devices and components described in the exemplary embodiments may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

The exemplary embodiments of the present invention may provide a method, apparatus, and system for appropriately evaluating a first user distributing an online document.

Also, the exemplary embodiments of the present invention may provide a method, to apparatus, and system for determining a number of effective user accesses to the online document distributed by the first user through a link address of the online document.

Furthermore, the exemplary embodiments of the present invention may provide a method, apparatus, and system for objectively evaluating the first user contribution to distribute the online document, based on unique information of the first user used in generating the link address of the online document.

Also, the exemplary embodiments of the present invention may provide a method, apparatus, and system for preventing an invalid access by using a unique number or an access history for each user equipment having received the link address of the online document to evaluate the first user contribution.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An online document distribution method for a mobile device, the method comprising:
receiving a selection of one online document among a plurality of online documents from a first user;
generating a link address of the selected online document using unique information of the first user through an application installed in a mobile device of the first user;
transmitting the generated link address to at least one second user device selected by the first user;
to detecting an access to the selected online document through the generated link address; and
updating a score of the first user in response to the detected access to the selected online document.

2. The method of claim 1, further comprising:
providing a list of the plurality of online documents.

3. The method of claim 1, wherein the generating of the link address of the selected online document comprises:
encrypting at least one of unique information of the first user, a number of the online document, and a language identifier using a predetermined encryption scheme; and
combining the encryption result with a base uniform resource locator (URL) of the online document.

4. The method of claim 1, wherein the transmitting of the generated link address comprises:
selecting a transmission medium.

5. The method of claim 4, wherein the selecting of the transmission medium comprises:
selecting one server among a plurality of servers; and
transmitting the generated link address through the selected server.

6. The method of claim 1, wherein the detecting of the access to the selected online document comprises:
to detecting the access to the selected online document by the second user device through the generated link address; and
determining whether a number of accesses by the second user device is greater than a predetermined value.

7. The method of claim 6, wherein the determining whether the number of accesses by the second user device is greater than the predetermined value further comprises:
determining whether the number of accesses by the second user device is greater than the predetermined value, based on a unique number assigned to the second user device or an access history of online documents accessed by the second user device.

8. The method of claim 1, wherein the updating of the score of the first user further comprises:
providing the first user with a reward in a form of a coupon, points, and cash, based on the score of the first user.

9. A method of distributing a document of a business subscriber online, the method comprising:
providing a document registered and distributed by a business subscriber through an application installed in a mobile device of a first user;
identifying unique information of the first user;
generating a link address of the document using the unique information of the first user;
transmitting the generated link address to at least one second user device selected by the first user;
detecting an access to the document through the generated link address; and
updating a score of the first user in response to the detected access to the document.

10. The method of claim 9, wherein the identifying of the unique information of the first user comprises:
identifying the unique information of the first user to select a predetermined document from a list of documents registered and distributed by the business subscriber.

11. The method of claim 9, wherein the updating of the score of the first user further comprises:
transmitting the updated score to the business subscriber corresponding to the first user.

12. A computer readable recording media storing a program implementing the method of claim 1.
